(19) United States
(12) Patent Application Publication
(10) Pub. No.: US 2020/0201054 A1
(43) Pub. Date: Jun. 25, 2020

(54) HEAD-UP DISPLAY DEVICE

(71) Applicant: NIPPON SEIKI CO., LTD., Niigata (JP)

(72) Inventors: Yuki MASUYA, Niigata (JP); Makoto HADA, Niigata (JP)

(21) Appl. No.: 16/623,650

(22) PCT Filed: Jun. 27, 2018
(86) PCT No.: PCT/JP2018/024268

§ 371 Date: Dec. 17, 2019

(30) Foreign Application Priority Data
Jun. 29, 2017 (JP) 2017-128088

(51) Int. Cl. G02B 27/01; B60K 35/00; B60R 11/02

(52) U.S. Cl. CPC G02B 27/0179; G02B 2027/0185; B60R 11/02; B60K 35/00

(57) ABSTRACT

In order to suppress changes in the angle of a virtual image relative to the apparent road surface, a display unit projects display light for displaying a virtual image inclined so as to be nonparallel with the vertical direction, with the horizontal direction as the axis; a display position control unit adjusts at least the position in the vertical direction at which the virtual image V displayed by the display unit is perceived, and, if the display position control unit increases the height of the virtual image V, a display angle control unit increases the inclination angle θ such that the far side of the virtual image rises up towards the viewer.

### TECHNICAL FIELD

The present invention relates to a head-up display device that allows an occupant of a vehicle to visually recognize a virtual image.

### BACKGROUND ART

A head-up display device described in Patent Document 1 is capable of changing the position in an up-down direction (the height) of a virtual image to be displayed and thus gives various expressions by using the virtual image.

### PRIOR ART DOCUMENT

### Patent Document

Patent Document 1: Japanese Unexamined Patent Application Publication No. 2015-34945

### SUMMARY OF THE INVENTION

### Problems to be Solved by the Invention

However, when the height of the virtual image to be displayed is changed, the angle of the virtual image relative to a road surface may be recognized to be changed. Specifically, when the height of the virtual image recognized to be parallel to the road surface is elevated, one end on the far side of the virtual image is recognized to be located close to the road surface and one end on a near side of the virtual image is recognized to be separated from the road surface; therefore, the virtual image may be recognized not to be parallel to the road surface.

The present invention is intended to provide a head-up display device capable of inhibiting changes of an angle of a virtual image relative to an apparent road surface.

### Solution to Problem

In order to solve the above problem, the present invention adopts the following means. As summarized below, when changing the height of a virtual image to be visually recognized, a head-up display device of the present invention changes an inclination angle of the virtual image and thus inhibits changes of an angle of the visual image relative to an apparent road surface before and after the height of the virtual image changes.

The head-up display device according to a first aspect of the present invention includes: a display unit (20) configured to output display light (20a) that displays a virtual image (V); a display position control unit (31) configured to at least adjust a position in an up-down direction of the virtual image (V) visually recognizably displayed by the display unit (20); and a display angle control unit (32) configured to, when the position in the up-down direction of the virtual image (V) is elevated by the display position control unit (31), increase an inclination angle (θ) of the virtual image such that the far side of the virtual image (V) is moved upward toward a viewer.

According to the first aspect, when the position in the up-down direction (the height) of the virtual image is elevated, the far side of the virtual image is prevented from being visually recognized to be lowered compared to a case where the height of the virtual image is low.

Further, in the head-up display device according to a second aspect subject to the first aspect, the display angle control unit (32) may adjust the inclination angle (θ) in a range where the far side of the virtual image (V) is not located below the near side of the virtual image (V) in the up-down direction.

According to the second aspect, the virtual image is visually recognizably overlapped with a road surface in an actual scene in a state where the far side of the virtual image is parallel to the road surface or moved upward. Therefore, the virtual image can be avoided from being displayed uncomfortably such that an extended line from the near side to the far side of the virtual image is intersected with the road surface.

Furthermore, in the head-up display device according to a third aspect subject to the first or second aspect, the display position control unit (31) can additionally adjust a position in a right to left direction of the visually recognizable virtual image (V), and when the display position control unit (31) moves the virtual image (V) from the display center to right or left in the right to left direction, the display angle control unit (32) may increase the inclination angle (θ) such that the far side of the virtual image (V) is moved upward toward the viewer.

According to the third aspect, a change in an angle of the virtual image relative to the apparent road surface, which is caused by a change in the position of the virtual image in the right to left direction can be inhibited.

Moreover, in the head-up display device according to a fourth aspect subject to any one of the first to third aspects, a viewpoint height acquisition means (33) configured to acquire the height of viewpoint of the viewer is further provided. When the height of viewpoint acquired from the viewpoint height acquisition means (33) is low, the display angle control unit (32) may increase the inclination angle (θ) such that the far side of the virtual image (V) is moved upward toward the viewer.

According to the fourth aspect, a change in an angle of the virtual image relative to the apparent road surface, which is caused by a change in the height of viewpoint of the viewer can be inhibited.

### BRIEF DESCRIPTION OF THE DRAWINGS

FIG. 1 is a diagram illustrating the configuration of a head-up display device according to an embodiment of the present invention.

FIG. 2A is a diagram illustrating an example of a display area in which a virtual image is displayed by the head-up display device of FIG. 1.

FIG. 2B is a diagram illustrating an example of a display area in which a virtual image is displayed by the head-up display device of FIG. 1.

FIG. 2C is a diagram illustrating an example of a display area in which a virtual image is displayed by the head-up display device of FIG. 1.

FIG. 3 are diagrams each illustrating the relationship between the inclination angle of a virtual image displayed by the head-up display device of FIG. 1 and the height of viewpoint of a viewer.

### MODE FOR CARRYING OUT THE INVENTION

Embodiments described below are used to facilitate understanding of the present invention, and the those skilled in the art should note that the present invention is not limited unduly by the embodiments described below.

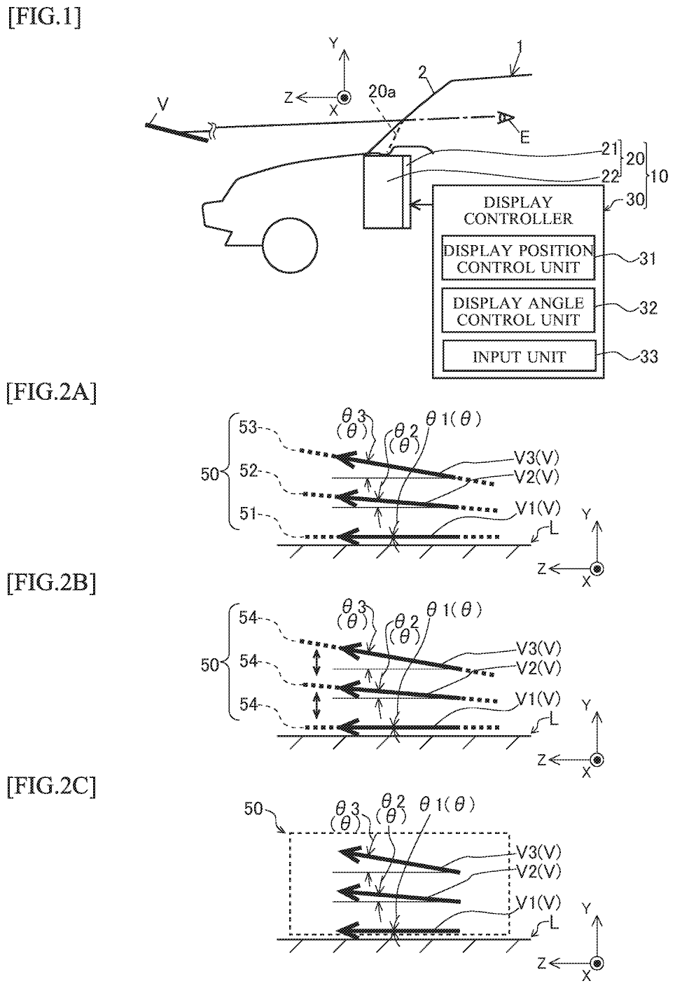

FIG. 1 is a diagram illustrating the configuration of a head-up display device (herein, also referred to as a HUD device) 10. Additionally, in FIG. 1, the front to back direction of a vehicle 1 is the Z direction (the front direction is the positive Z direction). The direction along the right to left direction (width direction of the vehicle 1) of the vehicle 1 is the X direction (the left direction is the positive X direction). The up-down direction is the Y direction (the upper direction is the positive Y direction).

The HUD device 10 mounted in the vehicle 1 includes: a display unit 20 including a display 21 that displays an image and a projector 22 that projects a display light 20a of the image displayed by the display 21 toward a front windshield 2; and a display controller 30 that can control the position and inclination angle θ of a virtual image V displayed by the display unit 20.

The HUD device 10 acquires various types of information from an input unit 33 described below, and changes the position (the position in the up-down direction Y, the position in the right to left direction X) of the virtual image V based on the various information. For example, the HUD device 10 may change the position of the virtual image V based on a signal requested from a vehicle ECU (not illustrated) of the vehicle 1, an operation signal of an operation unit (not illustrated) provided in the vehicle 1, or detection signals from various sensors provided in the vehicle 1. In addition, the virtual image V displayed by the HUD device 10 is displayed inclined so as not to be parallel to the up-down direction Y with respect to the right to left direction X as the axis.

The display controller 30 includes: a display position control unit 31 that controls the position in the up-down direction (the height) of the virtual image V displayed by the HUD device 10; a display angle control unit 32 that controls the angle (inclination angle θ) of the virtual image V with respect to the right to left direction X as the axis; and the input unit 33 that acquires aforementioned various information. In addition, the display controller 30 may generate, based on the various image input from the input unit 33, image data as a source of an image displayed by the display 21. Alternatively, the display controller may be a device to which image date is input from the input unit 33. The display angle control unit 32 controls the inclination angle θ of the virtual image V in accordance with the height of the virtual image V, which is adjusted by the display position control unit 31. Alternatively, the display angle control unit 32 reads table data associated with the height and inclination angle θ of the virtual image V or calculates the inclination angle θ from the height of the virtual image V, and thereby may obtain the inclination angle θ.

### Embodiments of HUD 10

FIGS. 2A, 2B, and 2C are diagrams each illustrating a display area 50 in which the position of the virtual image V is adjustable. First to third embodiments of the HUD 10 capable of generating the display area 50 illustrated in FIGS. 2A, 2B, and 2C will be described below.

### First Embodiment

First, referring to FIG. 2A, the HUD device 10 in the first embodiment illustrated in FIG. 2A is structured such that the display area 50 in which the position of the virtual image V is adjustable is configured by plural fixed virtual image display surfaces. The HUD device 10 of the first embodiment generates, in ascending order of heights in the up-down direction, a first virtual image display surface 51 on which a first virtual image V1 can be displayed, a second virtual image display surface 52 on which a second virtual image V2 can be displayed, and a third virtual image display surface 53 on which a third virtual image V3 can be displayed. The first virtual image display surface 51, the second virtual image display surface 52, and the third virtual image display surface 53 are typically flat surfaces but may not be strictly flat surfaces. For example, the HUD device 10 as just described allows light from the single display 21 to diverge. Alternatively, the HUD device 10 is provided with the plural displays 21 and thereby forms plural image display surfaces (not illustrated) on which images are respectively displayed. Thus, the plural virtual image display surfaces 51, 52, 53 are formed. The display position control unit 31 switches between the virtual image display surfaces 51, 52, 53 each displaying the virtual image V and thereby can adjust the height of the virtual image V in the up-down direction Y. At the same time, the inclination angle θ of the virtual image V becomes an inclination angle θ of each of the displayed virtual image display surfaces 51, 52, 53. In other words, in such a configuration, the display position control unit 31 also functions as the display angle control unit 32, which controls the inclination angle θ of the virtual image V. In the HUD device 10 of the first embodiment, an angle between the image display surface corresponding to the first virtual image display surface 51 disposed on the inner side and the image display surface corresponding to the second virtual image display surface 52 are adjusted in advance such that an inclination angle θ2 of the second virtual image display surface 52 is larger than an inclination angle θ1 of the first virtual image display surface 51 disposed lower than the second virtual image display surface 52, thereafter being fixed. In addition, an angle between the image display surface corresponding the second virtual image display surface 52 disposed on the inner side and the image display surface corresponding to the third virtual image display surface 53 is adjusted in advance such that an inclination angle θ3 of the third virtual image display surface 53 is larger than the inclination angle θ2 of the second virtual image display surface 52 disposed lower than the third virtual image display surface 53, thereafter being fixed.

### Second Embodiment

Next, referring to FIG. 2B, the HUD device 10 in the second embodiment illustrated in FIG. 2B is structured such that the display area 50 in which the position of the virtual image V is adjustable is formed by moving virtual image display surfaces 54. In the HUD device 10 as just described, the display 21 is moved and rotated by an actuator (not illustrated) and thereby the position and inclination angle θ of each of the virtual image display surfaces 54 can be adjusted. Likewise, the projector 22 is also moved and/or rotated by an actuator (not illustrated) and thereby may assist to adjust the position and inclination angle θ of the virtual image display surface 54. In accordance with the operation of the actuator, the display position control unit 31 moves the virtual image display surface 54 displaying the virtual image V; therefore, the height of the virtual image V in the up-down direction Y is adjusted. At the same time, the actuator is operated in accordance with the height of the virtual image V in the up-down direction Y and thereby the display angle control unit 32 rotates the virtual image display surface 54. Therefore, the inclination angle θ of the virtual image V is also adjusted.

### Third Embodiment

Next, referring to FIG. 2C, the HUD device 10 in the third embodiment illustrated in FIG. 2C can adopt the following method such as a parallax division method including a parallax barrier method, a lenticular lens method, or the like, a space reproduction method including a light field method or a holographic method, a screen high-speed vibration system to vibrate a screen displaying an image at high-speed, a transmittance adjustment screen system, as described in JP2016-212318 A, in which plural screens each including a dimmable layer capable of adjusting transmittance are stacked in the thickness direction and projection images are projected by a projector toward the plural screens while being switched at high-speed, and the transmittance of each of the plural screens is adjusted appropriately in accordance with the high-speed switching of the projection images and thus actual 3D images are displayed inside, a method, as described in JP2004-168230 A, in which plural liquid crystal display elements are stacked in the thickness direction and thereby actual 3D images are displayed inside, or the like. Accordingly, the HUD device 10 can display the virtual image V in a three-dimensional space of the right to left direction X, the up-down direction Y, and the depth direction Z. The display position control unit 31 controls three-dimensional data for controlling the arrangement of the virtual image V; therefore, the height in the up-down direction Y of the virtual image V in the display area 50 is adjusted. At the same time, the display angle control unit 32 controls three-dimensional data for controlling the arrangement of the virtual image V or data on the angle of the virtual image V; therefore, the inclination angle θ of the virtual image V is also adjusted.

In addition, the HUD device 10 of the foregoing embodiments is capable of adjusting the position in the right to left direction X of the virtual image V. When the display position control unit 31 moves the virtual image V from the display center to right or left in the right to left direction, the display angle control unit 32 may increase the inclination angle θ of the virtual image V such that the far side of the virtual image V is moved upward toward a viewer.

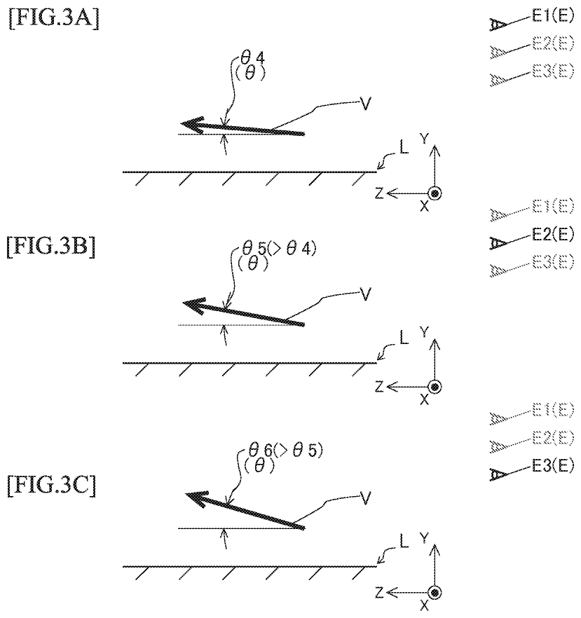

FIG. 3 are diagrams each illustrating the relationship between the height of viewpoint E of a viewer and the inclination angle θ of the virtual image V. The HUD device 10 of the present invention is capable of acquiring the height of viewpoint of the viewer from the input unit (viewpoint height acquisition means) 33. The display angle control unit 32 may gradually increase the inclination angle θ of the virtual image V (θ4<θ5<θ6) such that the far side of the virtual image V is moved upward toward the viewer as the height of viewpoint acquired from the input unit 33 gradually lowers (viewpoint E1<E2<E3).

Note that the present invention is not limited by the above embodiments. Modifications (including deletion of components) can be made as appropriate without departing from the scope of the present invention.

### DESCRIPTION OF REFERENCE NUMERALS

1 Vehicle
2 Front windshield
10 HUD device
20 Display unit
20a Display light
21 Display
22 Projector
30 Display controller
31 Display position control unit
32 Display angle control unit
33 Input unit
50 Display area
51 First virtual image display surface
52 Second virtual image display surface
53 Third virtual image display surface
54 Virtual image display surface
E Viewpoint
V Virtual image
θ Inclination angle

1. A head-up display device comprising:
a display unit configured to output display light that displays a virtual image;
a display position control unit configured to at least adjust a position in an up-down direction of the virtual image visually recognizably displayed by the display unit; and
a display angle control unit configured to, when the position in the up-down direction of the virtual image is elevated by the display position control unit, increase an inclination angle of the virtual image such that a far side of the virtual image is moved upward toward a viewer.

2. The head-up display device according to claim 1, wherein the display angle control unit is configured to adjust the inclination angle in a range where the far side of the virtual image is not located below a near side of the virtual image in the up-down direction.

3. The head-up display device according to claim 1, wherein the display position control unit is further configured to adjust a position in a right to left direction of the visually recognizable virtual image, and
when the display position control unit moves the virtual image from a display center to right or left in the right to left direction, the display angle control unit increases the inclination angle such that the far side of the virtual image is moved upward toward the viewer.

4. The head-up display device according to claim 1, further comprising a viewpoint height acquisition means configured to acquire a height of viewpoint of the viewer, wherein when the height of viewpoint acquired from the viewpoint height acquisition means is low, the display angle control unit increases the inclination angle such that the far side of the virtual image is moved upward toward the viewer.

5. The head-up display device according to claim 2, wherein the display position control unit is further configured to adjust a position in a right to left direction of the visually recognizable virtual image, and
when the display position control unit moves the virtual image from a display center to right or left in the right to left direction, the display angle control unit increases the inclination angle such that the far side of the virtual image is moved upward toward the viewer.
